(19) United States
(12) Patent Application Publication
(10) Pub. No.: US 2025/0100185 A1
(43) Pub. Date: Mar. 27, 2025

(54) METHOD OF MILLING BRITTLE MATERIALS USING A POLYCRYSTALLINE DIAMOND END MILLING TOOL

(71) Applicant: Element Six (UK) Limited, Didcot, Oxfordshire (GB)

(72) Inventor: Luiz Fernando Penna Franca, Didcot, Oxfordshire (GB)

(21) Appl. No.: 18/857,869

(22) PCT Filed: Apr. 20, 2023
(86) PCT No.: PCT/EP2023/060233

§ 371 Date: Oct. 18, 2024

(30) Foreign Application Priority Data
Apr. 21, 2022 (GB) 2205785.5

(51) Int. Cl. B28D 1/18; B23C 5/10; B28D 5/02

(52) U.S. Cl. CPC B28D 1/186; B23C 5/10; B28D 5/02; B23C 2222/28; B23C 2226/125; B23C 2226/315; B23C 2226/45

(57) ABSTRACT

Herein is provided a method of milling a brittle workpiece (46) using a milling tool (10), •—the workpiece (46) comprising a material, the material having a Ductile-Brittle Transition Undeformed Chip Thickness, DBhᵣₙ, •—the milling tool (10) comprising a tool shank (12) having an axis of rotation (14), and further comprising a tool head (16) comprising superhard material at one end thereof, the tool head (16) having a diameter (42), and •—operating the milling tool (10) such that an Undeformed Chip Thickness, hₘ, of the workpiece (46) is less than said Ductile-Brittle Transition Undeformed Chip Thickness, DBhₘ of the material.

### FIELD OF THE INVENTION

This disclosure relates to a method of milling brittle materials such as glass, sapphire and zirconia. In particular, it relates to a milling method that uses an end milling tool comprising polycrystalline diamond (PCD).

### BACKGROUND

Milling is a cutting process whereby a tool with multiple cutting surfaces is rotated to remove material from the surface of a work piece. Such tools, also known as cutters, come in all shapes and sizes, depending on the design of the workpiece. The tool has an elongate shank or handle, adjacent to a tool head which has the profiled cutting surfaces. The shank is mounted in a milling tool holder that is then mounted in the tool spindle of the machine and rotated.

End milling cutters are the most common form of milling cutter and they are available in a wide variety of heights, diameters and types. End milling cutters are used for machining the faces and sides of a workpiece. During a typical milling operation, the cutter moves perpendicularly to its axis of rotation, allowing it to remove material from the workpiece at the perimeter of the cutter. End milling cutters are used for slotting, profiling, contouring, counter-boring and reaming. The spiral-shaped cutting edges on the side of the end milling cutter are known as ‘flutes’ and they provide an empty path for the cutting chips to escape from when the end milling cutter is rotating in a workpiece.

End milling cutters are commonly made out of high-speed steel (i.e. cobalt steel alloys) or from tungsten carbide in a cobalt lattice. Carbide is considerably harder, more rigid, and more wear resistant than high-speed steel. However, carbide is brittle and tends to chip instead of wear. The choice of material depends on the material to be cut as well as on the maximum spindle speed of the machine.

The use of coatings increases the surface hardness of the tool. This enables greater tool life and cutting speed. Standard coatings include Titanium Nitride (TiN), Titanium Carbonitride (TiCN) and Aluminium Titanium Nitride (AlTiN).

For workpieces made of harder materials, diamond electroplated tool heads are often used. In electroplated cutters, hundreds of individual diamond grits are embedded into a bonding agent on the surface of the tool head to provide numerous cutting surfaces and edges. However, a problem with electroplated milling tools is that the diamond grits are prone to pull-outs from the bonding agent, rendering the workpiece vulnerable to unwanted scratches from the rogue grits. Another problem is that diamond electroplated tools have a limited tool life, necessitating regular tooling changes and increasing the cost of production with every tool required.

In micro end milling cutters, the outer diameter of the tool head is usually no more than 15 mm, and is typically in the range of 6 to 10 mm. Micro end milling cutters are deployed in milling operations during the construction of, for example, mobile phone handset shells. Handset shells are typically made from aluminium, polycarbonate or ceramic. One of the incumbent technologies is diamond electroplated micro end milling cutters.

A common problem associated with the use of diamond electroplated tools is that they can cause sub-surface damage to the handset shell (or other workpiece), which causes it to weaken and increases the risk of cracking in use.

It is an object of the invention to address the issue of subsurface damage when milling mobile phone handset shells made from brittle materials such as glass and the like.

### SUMMARY OF THE INVENTION

In accordance with the invention, there is provided a method of milling a brittle workpiece using a milling tool, for example an end milling tool. The workpiece comprises a material, and the material has a Ductile-Brittle Transition Undeformed Chip Thickness, DBhₘ. The milling tool comprises a tool shank having an axis of rotation, and further comprises a tool head comprising superhard material at one end thereof. The tool head has a diameter D. The tool head may comprise a plurality of flutes arranged in a peripheral surface thereof. The method comprises operating the milling tool such that an Undeformed Chip Thickness, hₘ, of the workpiece is less than said Ductile-Brittle Transition Undeformed Chip Thickness, DBhₘ, of the material.

As an option, the Undeformed Chip Thickness, hₘ, is in the range of 0.05 to 0.30 μm, for example 0.05 to 0.25 μm, for example 0.10 to 0.25 μm, for example 0.15 to 0.25 μm, for example 0.20 to 0.25 μm. The Undeformed Chip Thickness, hₘ, may be at least 0.05, 0.10, 0.15 or 0.20 μm. The Undeformed Chip Thickness, hₘ, may be at most 0.25 or 0.30 μm.

As an option, the superhard material comprises any of high pressure high temperature polycrystalline diamond, chemical vapour deposition diamond, and polycrystalline cubic boron nitride.

As an alternative option, the superhard material comprises polycrystalline chemical vapour deposition diamond coated on a cemented carbide substrate.

As an option, the superhard material is monolithic polycrystalline diamond. As an alternative option, the superhard material is polycrystalline diamond adjoining a carbide backing portion.

As an option, the tool head comprises at least two tiers, and the tiers are axially displaced from each other and separated by a non-cutting portion of the tool head.

The material to be milled optionally comprises any of glass, ceramic, polymer, composites, metallic materials, ferrous and non-ferrous brittle materials and metal-ceramic composites.

As an option, the outer diameter of the milling tool may be in the range of 1 to 15 mm, for example 2 to 15 mm, for example 3 to 15 mm, for example 4 to 15 mm, for example 4 to 10 mm, for example 6 to 8 mm. The outer diameter of the milling tool may be at least 1, 2, 3, 4, 5 or 6 mm. The outer diameter of the milling tool may be at most 8, 9, 10, 11, 12, 13, 14 or 15 mm.

As an option, the Undeformed Chip Thickness, hₘ, may be at least 5%, or at least 10%, or at least 15%, or at least 20%, or at least 25%, or at least 30%, or at least 35%, or at least 40%, or at least 45%, or at least 50%, or at least 60%, or at least 65%, or at least 70%, or at least 75%, or at least 80%, or at least 85%, or at least 90%, or at least 95%, or at least 99% of the Ductile-Brittle Transition Undeformed Chip Thickness, DBhₘ.

As an option, the Undeformed Chip Thickness, hₘ, may be at most 5%, or at most 10%, or at most 15%, or at most 20%, or at most 25%, or at most 30%, or at most 35%, or at most 40%, or at most 45%, or at most 50%, or at most 60%, or at most 65%, or at most 70%, or at most 75%, or at most 80%, or at most 85%, or at most 90%, or at most 95%, or at most 99% of the Ductile-Brittle Transition Undeformed Chip Thickness, DBhₘ.

Further preferable and/or optional features of the invention are provided in the dependent claims.

### BRIEF DESCRIPTION OF THE DRAWINGS

The invention will now be more particularly described, by way of example only, with reference to the accompanying drawings, in which:

FIG. 1 is a perspective view of a tool for use in accordance with the invention, with a first example of a tool head;

FIG. 2 is a front view of the tool of FIG. 1;

FIG. 3 is an enlarged view of portion X from FIG. 2;

FIG. 4 is a front view of a second example of a tool head;

FIG. 5 is a front view of a third example of a tool head;

FIG. 6 is a front view of a fourth example of a tool head;

FIG. 7 is a front view of a fifth example of a tool head;

FIG. 8 is an annotated version of the tool head of FIGS. 5 and/or 6;

FIG. 9 is another annotated version of the tool head of FIGS. 5 and/or 6;

FIG. 10 is a schematic indicating the lateral cross-section of the flutes in the tool head;

FIG. 11 is a schematic indicating the cutting action of the flutes during use; and

FIG. 12 is a schematic used to define the Undeformed Chip Thickness (hₘ) during milling and also the Ductile-Brittle Transition Undeformed Chip Thickness (DBhₘ) of the workpiece material.

FIG. 13 is a plot of number of teeth (Z_{c}) vs undeformed chip thickness (hₘ) when the tool diameter D is 6 mm, the depth of cut aₑ is 0.015 mm, the table feed V_{f} is 1300 mm/min, and the spindle speed is 24000 RPM.

FIG. 14 is a plot of table feed V_{f} vs undeformed chip thickness (hₘ) when the tool diameter D is 6 mm, the depth of cut a is 0.015 mm, the spindle speed is 24000 RPM, and the quantity of teeth Z_{c} is 24.

Throughout the embodiments, similar parts are denoted by the same reference numeral and a further description is omitted for brevity.

### DETAILED DESCRIPTION

The following description refers to a tool head comprising a superhard material. In the examples, polycrystalline diamond (PCD) is referred to, but this is by way of example only. For milling ferrous materials, polycrystalline cubic boron nitride is preferred. Furthermore, while PCD may be used, other forms of synthetic diamond may be used, such as chemical vapour deposition (CVD) diamond.

Furthermore, the following description refers to milling glass by way of example, but it will be appreciated that the same tool configuration can be used for milling other types of material. A non-limiting list of materials that can be milled includes glass, ceramic, polymer, composites, metallic materials, ferrous and non-ferrous brittle materials and metal-ceramic composites.

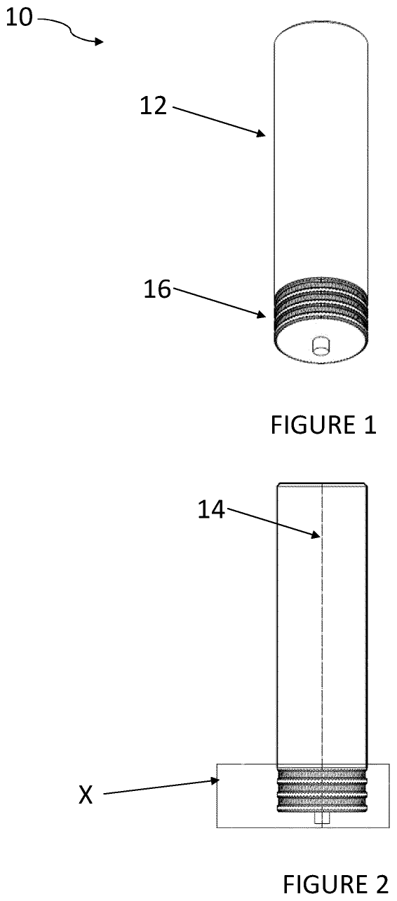

Referring firstly to FIGS. 1 to 3, a tool for milling glass is indicated generally at 10. The tool comprises a tool shank 12 having a longitudinal axis of rotation 14, and further comprises a tool head 16 at one end of the shank 12. The tool head 16 comprises at least one tier 18 (i.e. a stage or a level), the or each tier comprising a plurality of flutes 20 extending circumferentially around the tool head 16. In any one tier 18, all the flutes are in a band, i.e. they are in axial alignment with each other. Additional tiers are axially displaced with regards to the initial tier. A tool with multiple tiers therefore has tiers that are co-axially aligned and adjacent to each other.

The tool head 16 in this example comprises polycrystalline diamond (PCD).

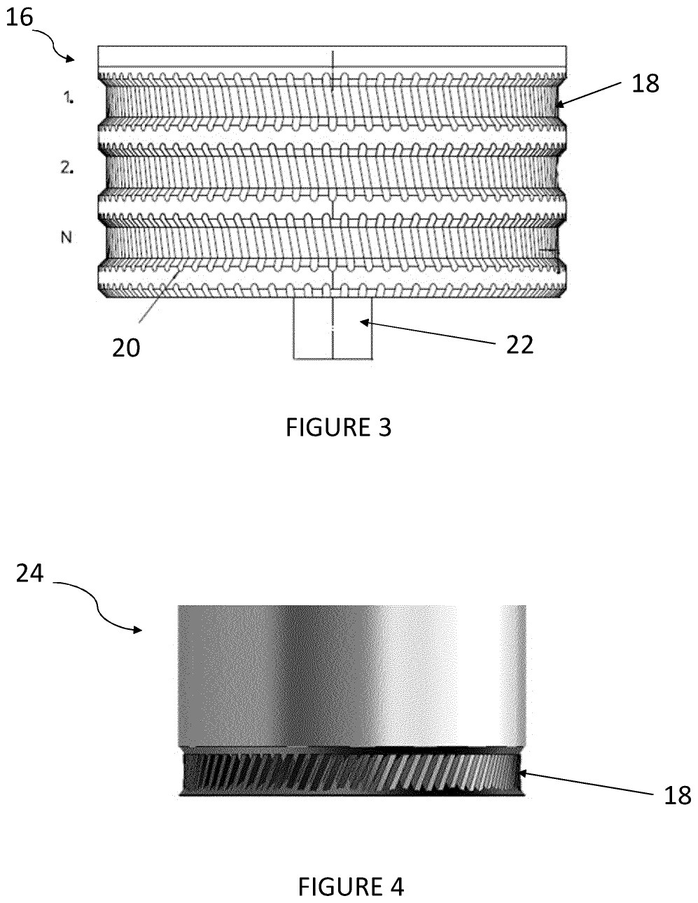

FIG. 3 shows a first example of a tool head 16. Tool head 16 comprises three tiers 18a, 18b, 18c and a notch element 22. Tier 18a corresponds to the tier closest to the shank, tier 18c corresponds to the tier furthest away from the shank, and tier 18b corresponds to the tier axially intermediate tiers 18a and 18c. Each tier 18 comprises a plurality of flutes. The flutes 20 are provided in an outer surface of the tool head. The flutes 20 extend around the entire circumference of the tool head 16. The flutes 20 are created in the outer surface using a laser which initially ablates unwanted material, thereby creating recesses between precursor flutes 20, and subsequently shapes the precursor flutes according to a desired profile into a final flute 20 configuration. More detail on the flutes 20 is provided later.

Each tier 18 may be separated from an adjacent tier 18 by a non-cutting portion 17 of the tool head 16.

The notch element 22 is configured to carve a correspondingly shaped notch into a workpiece, for example a microphone aperture in a mobile phone handset shell. As an example only, the notch element 22 may have a diameter of up to 1 mm and a height of up to 1 mm. The notch element 22 is entirely optional and may be omitted.

In FIG. 4, a second example of a tool head 24 is shown. In this example, a single tier 18a is provided.

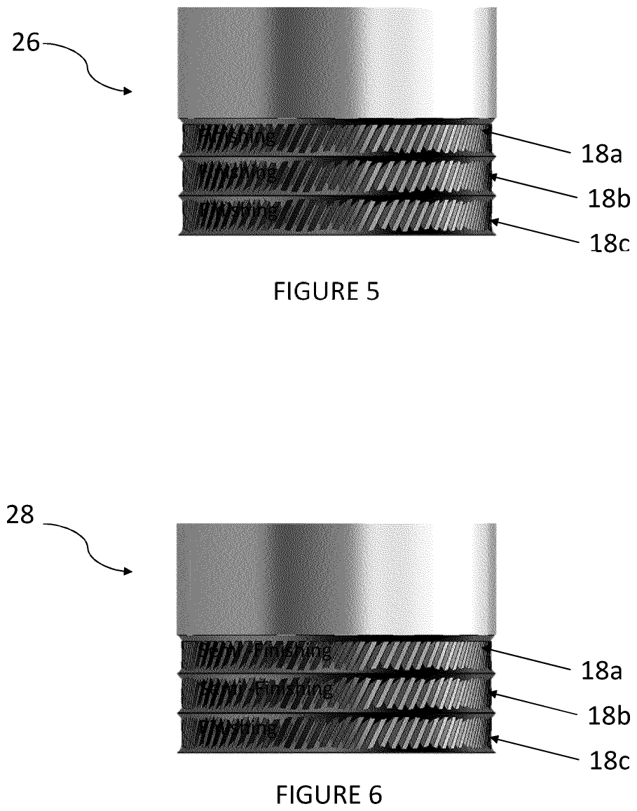

Turning now to FIG. 5, a further example of a tool head 26 is shown. In this example, three tiers 18a,18b, 18c are again provided. Each of the three tiers 18a, 18b and 18c is configured for finishing operations. However, the three tiers may all be configured for roughing, or alternatively they may all be configured for semi-finishing. The advantage of the configuration where all tiers are configured for the same milling operation is that it extends the service life of the tool by a factor of ‘n’ where ‘n’ is the quantity of tiers. As the first tier, whichever one it might be that is used first, wears out, then the spindle can be extended or retracted as appropriate, to move one of the other tiers into position. This is repeated as and when required, depending on the quantity of tiers 18 provided. Since the wear rate is the same for all three tiers, the operational life of the tool is maximised.

In FIG. 6, a further example of a tool head 28 is shown. In this embodiment, three tiers 18a, 18b, 18c are again provided. The first and second tiers 18a, 18b respectively, are configured for semi-finishing milling operations. Only the third tier 18c is configured for finishing milling operations. One of the advantages of this configuration is that, unlike the example given in FIG. 5, it does not require the additional tool change between milling operations. The tool is multi-functional and can be used for more than one specific milling operation, thereby reducing machine downtime and maximising operational equipment effectiveness. A tool configured for more than one type of milling operation may be considered to be a ‘multi-tool’.

The inventors have found that the tier furthest away from the shank 12 experiences the greatest forces and greatest moments during use and therefore in principle would wear away at the greatest rate. With higher moments also comes less stability and higher vibrations. It is important to consider that the wear morphology for the different milling operations varies too. For example, during finishing, wear tends to be abrasive wear exclusively, whereas during semi-finishing, chipping also occurs. These factors can all contribute towards premature failure of the tool. Therefore, it is important to consider the relative positioning of tiers 18 and their configuration for specific milling operations.

It is preferable to situate the tier configured for finishing operations furthest away from the shank because finishing operations require less forces and produce less wear. By placing the two tiers configured for semi-finishing closer to the shank, the wear rate across the three tiers 18 is balanced out and the life of the three tiers 18 is maximised. Also, by having a greater quantity of tiers for semi-finishing and roughing, since the probability of failure from chipping is higher from these milling operations, the tool provides operational redundancy and enables swift substitution with follow-on tiers, thereby minimising machine downtime.

Since a finishing operation produces half as much wear as a semi-finishing process, a tier configured for finishing will have a life that is approximately twice as long as a tier configured for semi-finishing. Having twice as many tiers for semi-finishing milling operations as tiers for finishing operations is therefore an optimum proportion. As an example, for a tool with six tiers in total, four of those tiers would be for semi-finishing and two of those tiers would be for finishing. To continue the example, a tool with twelve tiers in total, eight of those tiers would be for semi-finishing and four of those tiers would be for finishing.

In another example, not shown, the tiers 18 may all be configured exclusively for roughing operations.

Since a tier configured for roughing produces yet more wear than a tier configured for semi-finishing, the proportion of tiers configured for roughing will be at least double the quantity of tiers configured for semi-finishing, typically three to four times. For example, a single tool configured for all three milling operations may have nine tiers in total, may have six tiers for roughing, two tiers for semi-finishing, and one tier for finishing.

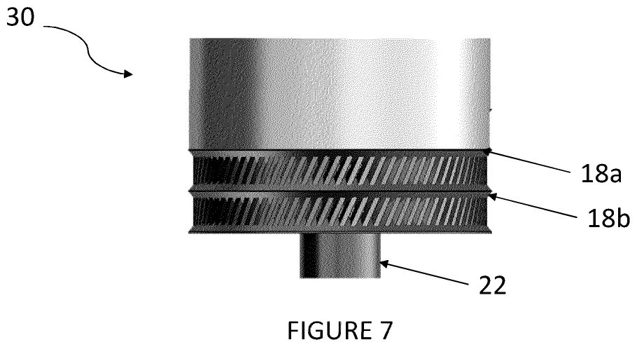

Turning now to FIG. 7, another example of a tool head 30 is shown. In this example, two tiers 18a and 18b are provided, each separated from the adjacent tiers by a non-cutting portion, and the tool head is provided with a notching element 22.

The tool shank 12 comprises cemented metal carbide, for example tungsten carbide, although other suitable materials are envisaged. Optionally, the tool shank 12 comprises a conduit (not shown) for carrying compressed air to the tool head to eject waste milling media from the flutes.

The tool head 16 is cylindrical and non-tubular. The tool head 16 in one example comprises a solid, monolithic PCD block. In this context, ‘monolithic’ means that the PCD has been sintered in a single piece in a single sintering operation. In the examples shown above, a PCD portion 32 is sinter-joined to a carbide backing layer 34, though this need not be the case and the carbide backing layer 34 may be omitted. The tiers 18 are provided in the PCD portion 32 of the tool head, and not in the carbide backing layer 34. The carbide backing layer 34 facilitates attachment to the tool shank 12, which can be achieved using any reasonable means.

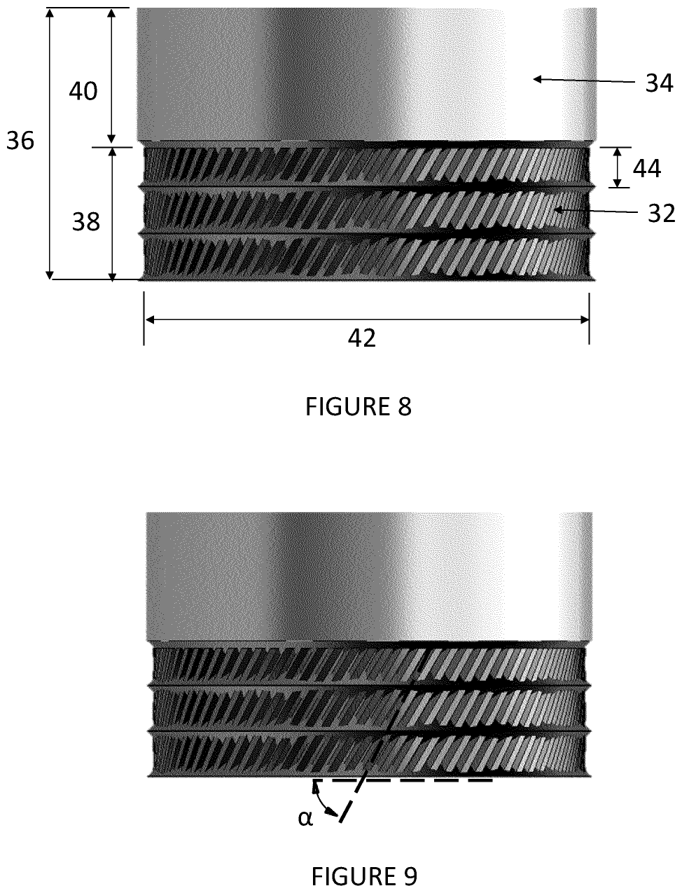

Referring to FIG. 8, an overall height of the tool head 16 is indicated at 36, and it is the sum of the height 38 of the PCD portion 32 and the height 40 of the carbide portion 34 if a carbide backing layer 34 is included (otherwise, it is only the height 38 of the PCD portion 32). Optionally, the height 36 of the tool head 16 is 0.5 mm to 12 mm. Optionally, the height 36 of the tool head 16 is 1 to 10 mm. Optionally, the height 36 of the tool head 16 is 6 mm. The height 38 of the PCD portion 32 may be in the range of 0.5 to 6 mm, for example 2.5 mm. It is envisaged that the height of the tool head may be in the order of nanometres (i.e. <100 nm), for example an overall height of 50 to 95 nm, or smaller. Optionally, the height 36 of the tool head 16 is no more than 12 mm.

The outer diameter of the tool 10 is indicated at 42 and is the largest, outermost, diameter of any of the tiers 18 and the shank 12. Individual tiers 18 may have different diameters to each other, depending, for example on which milling operation they are configured for. Optionally, all tiers 18 will have the same diameter.

Preferably, the tool 10, 24, 26, 28, 30 is a micro end milling tool which has an outer diameter of no more than 15 mm. Optionally, the outer diameter 42 of the tool is 10 mm. In one example of a micro end milling tool, the overall height of the tool, including tool shank 12 and tool head 16 may be around 200 mm.

The outer diameter of the milling tool may be in the range of 1 to 15 mm, for example 2 to 15 mm, for example 3 to 15 mm, for example 4 to 15 mm, for example 4 to 10 mm, for example 6 to 8 mm. The outer diameter of the milling tool may be at least 1, 2, 3, 4, 5 or 6 mm. The outer diameter of the milling tool may be at most 8, 9, 10, 11, 12, 13, 14 or 15 mm.

The height 44 of each tier 18 (measured axially, the same as the previous height measurements) depends on the quantity of tiers 18 and the height 38 of the PCD, regardless of whether it is backed or unbacked with carbide backing layer 34. As an example, for a tool head 16 comprising a PCD portion 32 backed with a carbide layer 34 which has a tool head 36 height of 6 mm, the height 38 of the PCD portion is 2.5 mm, and for three tiers, the height 44 of each tier is 0.6 to 0.7 mm.

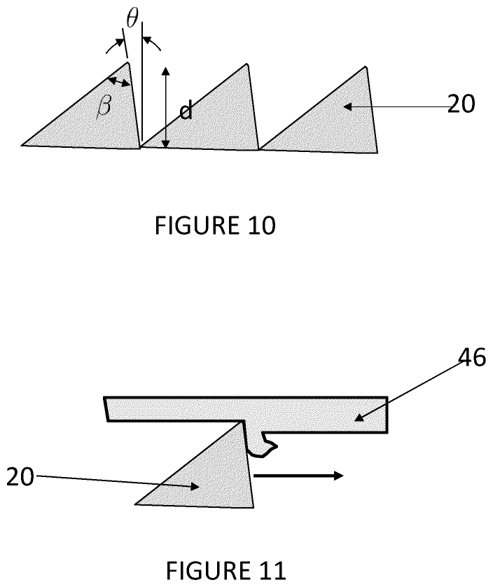

Referring to FIGS. 9, 10 and 11, each flute 20 has a triangular lateral cross-section. Various flute parameters influence certain factors. The helix angle, α and the flute depth, d affect the amount of clogging with waste debris that occurs between flutes during milling, and therefore the cleaning of the tool head 16. The helix angle, α, also affects tool stability. The flute angle β, rake (cutting) angle θ, and the quantity of flutes, N, have a direct effect on the surface finish, subsurface damage, tool performance (cutting forces) and tool life. FIG. 11 indicates schematically how each flute may cut the workpiece 46 as the tool advances laterally in the direction of the arrow during use.

The aforementioned parameters, helix angle, α, flute angle β, rake (cutting) angle θ, quantity of flutes, N and flute depth, d, within the or each tier are optimised depending on whether the aim of the milling operation is for roughing, semi-finishing or finishing in the context of milling glass or other similar brittle material. A roughing milling operation is generally intended to prepare the surface of the workpiece before the finishing operation. The purpose is to bring the dimension to a “rough” size of the final dimension. How this looks may be of little importance since the main aim is to clear away relatively large amounts of material quickly. Roughing will likely require a greater flute angle 3 than the other operations in order to provide a more substantial flute body to deal with the higher forces. This will reduce the quantity of flutes that can be fitted into a finite space, and therefore the quantity of flutes in a tier. A semi-finishing milling operation is typically the next stage after roughing. The purpose is to achieve a dimension even closer to the final dimension. A finishing milling operation is the final stage of machining a workpiece. A minimal quantity of workpiece material is removed, the workpiece is machined to size, the final dimension is obtained and sometimes the surface is further refined too.

The quantity of flutes on the milling tool may be in the range of 1 to 200, for example 2 to 200, for example 3 to 200, for example 4 to 200, for example 5 to 200, for example 6 to 200, for example 7 to 200, for example 8 to 200, for example 9 to 200, for example 10 to 200, for example 11 to 200, for example 12 to 200, for example 13 to 200, for example 14 to 200, for example 15 to 200, for example 16 to 200. The quantity of flutes may be at least 1, 2, 3, 4, 5, 6, 7, 8, 9, 10, 11, 12, 13, 14, 15 or 16. The quantity of flutes may be at most 20, 30, 40, 50, 60, 70, 80, 90, 100, 110, 120, 130, 140, 150, 160, 170, 180, 190 or 200.

One exemplary way to make one of the tool heads described is as follows: a typically circular blank shaped like a disc comprising superhard material such as PCD or PCBN is provided. At least one precursor tool head is machined from the disc. The quantity of precursor tool heads available depends on the diameter of the blank, the useable area devoid of defects and the outer diameter of the tool. The blank may be backed with a carbide backing layer or alternatively unbacked, or ‘freestanding’. The depth of the blank determines the depth of the tool head 16. A plurality of flutes is then formed in the precursor tool head using, e.g. laser ablation machining. The flutes are arranged in axially adjacent tiers. This latter step is then repeated as often as required, thereby forming a tool head comprising at least one tier, wherein the or each tier comprises a plurality of flutes extending circumferentially around the tool head.

An alternative way to make one of the tool heads described is as follows: a cemented carbide disc blank is provided and a precursor tool head is machined from the disc. A tier containing a plurality of flutes is formed in the precursor tool head using a laser. This step is repeated as required, to form a tool head comprising at least two tiers, each tier comprising a plurality of flutes extending circumferentially around the tool head, and wherein the tool head comprises the superhard material, and wherein the tiers are axially displaced from each other and separated by a non-cutting portion of the tool head. Finally, polycrystalline diamond is deposited on the plurality of flutes using chemical vapour deposition. Typically, hot filament CVD is used, but other forms of CVD such as microwave plasma CVD may be used. A final finishing operating may be required on the deposited diamond layer on the flutes.

As mentioned above, the quantity of flutes is one of the factors affecting the level of subsurface damage on the workpiece. Minimising subsurface damage is essential in the process of shaping mobile phone handset shells. However, tool design is not the only way of minimising such damage; in fact, it is a combination of both milling process conditions and tool design that have to be manipulated to achieve this goal.

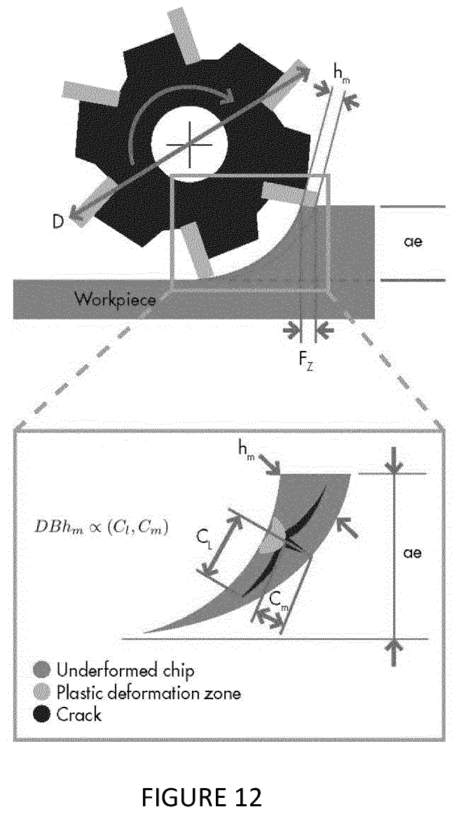

For adverse surface damage not to occur, brittle materials must be machined in the ductile mode. FIG. 12 shows a simplified schematic of the milling process, and identifies the Undeformed Chip Thickness hₘ, which in milling is defined as the distance between two consecutive cut surfaces. Also illustrated is the Ductile-Brittle Transition Undeformed Chip Thickness (DBhₘ) which is proportional to the product of the radii of lateral cracks (C₁) and the length of the medial cracks (Cₘ). To ensure that cracks generated at the cutting zone do not transition further into the workpiece and beyond, the Undeformed Chip Thickness hₘ, must be kept below a specific value, that of the Ductile-Brittle Transition Undeformed Chip Thickness DBhₘ. Table 1 below provides examples of DBhₘ for different workpiece materials.

TABLE 1

| | Ductile-Brittle |
|---|---|
| | Transition Undeformed |
| Material | Chip Thickness (DBhₘ) |
| Zirconia | 0.15-0.25 μm |
| Glass | 0.10-0.30 μm |
| Sapphire | 0.05-0.15 μm |

DBhₘ can be estimated using Equation 1 below, with the parameters defined in Table 2.

$${DBh}_{m} = α \frac{E}{H} {( \frac{Kc}{H} )}^{2} \qquad Equation 1$$

TABLE 2

| Parameter | Description (unit) |
|---|---|
| H | Hardness (Pa) |
| E | Young's Modulus (Pa) |
| K_{c} | Fracture Toughness (Mpa m^{1/2}) |
| α | Dimensionless tool factor [0-1, |
| | where 0 = sharp cutting edge, |
| | 1 = rounded or chamfered |
| | cutting edge] |

Achieving the required hₘ is primarily a function of the cutting parameters as defined by Equation 2 below, however, in practice, the tool design must also be incorporated into the whole application design.

$${h}_{m} = 2 {f}_{z} \sqrt{\frac{{a}_{e}}{D}} \qquad Equation 2$$

f_{z} is provided by Equation 3.

$${f}_{z} = \frac{{V}_{f}}{{nZ}_{c}} \qquad Equation 3$$

TABLE 3

| Parameter | Description (unit) |
|---|---|
| f_{z} | Feed per tooth (mm) |
| V_{f} | Table feed (mm/min) |
| N | Spindle speed (RPM) |
| Z_{c} | Quantity of teeth |
| aₑ | Depth of cut (mm) |
| D | Tool diameter (mm) |

Using Equations 2 and 3, it can be found that utilizing a tool with only 21 cutting edges would mean a spindle speed of 30,000 RPM is required. Few manufacturing orientated milling machines are capable of 30,000 RPM. Therefore, a higher quantity of cutting edges are needed for lower RPMs, e.g.; at ˜16,000 RPM, 40 edges are needed for the same hₘ imposed.

The development of laser ablation machines for cutting tool manufacture has opened up new possibilities in tool geometry design in PCD tool materials. A milling tool of 6 mm diameter, with a complex form and 40 or more cutting edges, would previously have been unachievable with traditional tool manufacturing methods.

Operating the milling tool, for example the end milling tool, may comprise controlling any one or more of the following: the depth of cut, the table feed, and the spindle speed.

The depth of cut may be in the range of 5 to 100 μm, for example 10 to 90 μm, for example 10 to 80 μm, for example 10 to 70 μm, for example 10 to 60 μm, for example 10 to 50 μm, for example 10 to 40 μm, for example 10 to 30 m, for example 15 to 20 μm.

The depth of cut may be at least 5, 10 or 15 μm. The depth of cut may be at most 20, 30, 40, 50, 60, 70, 80, 90 or 100 μm.

The table feed may be in the range of 200 to 1500 mm/min, for example 300 to 1500 mm/min, for example 400 to 1500 mm/min, for example 500 to 1500 mm/min, for example 600 to 1500 mm/min, for example 700 to 1500 mm/min, for example 800 to 1500 mm/min, for example 900 to 1500 mm/min, for example 1000 to 1500 mm/min, for example 1000 to 1400 mm/min.

The table feed may be at least 200, 300, 400, 500, 600, 700, 800, 900 or 1000 mm/min. The table feed may be at most 1400 or 1500 mm/min.

The spindle speed may be in the range of 1000 to 30000 rpm, for example 2000 to 30000 rpm, for example 3000 to 30000 rpm, for example 4000 to 30000 rpm, for example 5000 to 30000 rpm, for example 6000 to 30000 rpm, for example 7000 to 30000 rpm, for example 8000 to 30000 rpm, for example 9000 to 30000 rpm, for example 10000 to 30000 rpm, for example 11000 to 30000 rpm, for example 12000 to 30000 rpm, for example 13000 to 30000 rpm, for example 14000 to 30000 rpm, for example 15000 to 30000 rpm, for example 15000 to 29000 rpm, for example 15000 to 28000 rpm, for example 15000 to 27000 rpm, for example 15000 to 26000 rpm, for example 15000 to 25000 rpm, for example 15000 to 24000 rpm, for example 15000 to 23000 rpm, for example 15000 to 22000 rpm, for example 15000 to 21000 rpm, for example 15000 to 20000 rpm, for example 15000 rpm to 19000 rpm, for example 15000 rpm to 18000 rpm, for example 15000 rpm to 17000 rpm.

The spindle speed may be at least 1000, 2000, 3000, 4000, 5000, 6000, 7000, 8000, 9000, 10000, 11000, 12000, 13000, 14000 or 15000 rpm. The spindle speed may be at most 17000, 18000, 19000, 20000, 21000, 22000, 23000, 24000, 25000, 26000, 27000, 28000, 29000 or 30000 rpm.

### Example 1

For a tool diameter D, of 6 mm, a depth of cut aₑ, of 0.015 mm, a table feed V_{f}, of 1280 mm/min, quantity of teeth Z_{c}, of 40, and a spindle speed of 16,000 RPM, the feed per tooth f_{z} would be 0.002 mm, and the Undeformed Chip Thickness hₘ, would be 0.0002 mm, (or 0.2 μm). If these milling process conditions were followed in combination with the appropriate tool configuration, then minimal subsurface damage would result in glass.

However, they may not be sufficient for milling sapphire, as indicated in Table 1, and would need adapting.

### Example 2

The parameter hₘ describes the relationship between the operating conditions and the characteristics of the tool, i.e. the tool design. Either or both of these can be adjusted to arrive at suitable values of hₘ. In this example, the tool design is adjusted.

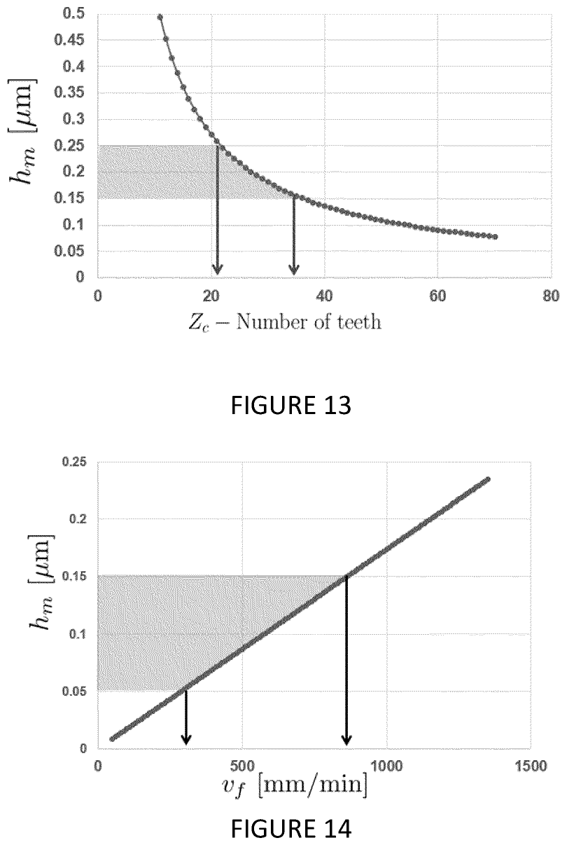

In this Example, it is desired to machine zirconia, which as noted above has a DBhₘ of 0.15 to 0.25 μm. In the case where the tool diameter D is 6 mm, the depth of cut aₑ is 0.015 mm, the table feed V_{f} is 1300 mm/min, and the spindle speed is 24000 RPM, the range of number of teeth which corresponds to the DBhₘ range for zirconia can be calculated using a plot as shown in FIG. 13 obtained using Equations 2 and 3. Specifically, to achieve hₘ of 0.15 to 0.25 μm (see shaded portion of FIG. 13), the quantity of teeth Z_{c} should be in the range of from 22 to 36 (see downward arrows in FIG. 13). Further optimization can then be performed to find the optimum hₘ, i.e. that which is less than the DBhₘ of the material. For example, if more than 36 teeth were used under the above conditions, then the hₘ would be less than 0.15 μm.

This will ensure minimal subsurface damage to the zirconia during milling.

### Example 3

The parameter hₘ describes the relationship between the operating conditions and the characteristics of the tool, i.e. the tool design. Either or both of these can be adjusted to arrive at suitable values of hₘ. In this example, the operating conditions are adjusted.

In this Example, it is desired to machine sapphire, which as noted above has a DBhₘ of 0.05 to 0.15 μm. In the case where the tool diameter D is 6 mm, the depth of cut aₑ is 0.015 mm, the spindle speed is 24000 RPM, and the quantity of teeth Z_{c} is 24, the range of table feed V_{f} which corresponds to the DBhₘ range for sapphire can be calculated using a plot as shown in FIG. 14 obtained using Equations 2 and 3. Specifically, to achieve hₘ of 0.05 to 0.15 μm (see shaded portion of FIG. 14), the table feed V_{f} should be in the range of from 290 to 865 mm/min (see downward arrows in FIG. 14). Further optimization can then be performed based to find the optimum hₘ, i.e. that which is less than the DBhₘ of the material. For example, the table feed V_{f} can be reduced below 290 mm/min to provide an hₘ of lower than 0.05 μm. This will ensure minimal subsurface damage to the sapphire during milling.

In summary, the inventors have found a way of achieving complex surface forms in brittle materials such as glass, meeting tight form and surface roughness tolerances. Harnessing the benefits of PCD, tool life is significantly enhanced and the deleterious effects of the electroplating manufacturing process on the environment is avoided.

While the method has been shown and described with reference to various examples, it will be understood by those skilled in the art that various changes in form and detail may be made without departing from the scope of the invention as defined by the appended claims.

For example, although the above examples include a monolithic PCD portion, in a less preferred example, the tool head may comprise two or more PCD segments stacked side by side adjacent to each other, each segment forming one or more of said tiers. In such an arrangement, the PCD segments maybe annular, aligned coaxially with the axis of rotation, and mounted about a hub extending from the tool shank.

1. A method of milling a brittle workpiece using a milling tool,
the workpiece comprising a material, the material having a Ductile-Brittle Transition Undeformed Chip Thickness, DBhₘ,
the milling tool comprising a tool shank having an axis of rotation, and further comprising a tool head comprising superhard material at one end thereof, the tool head having a diameter D, and
operating the milling tool such that an Undeformed Chip Thickness, hₘ, of the workpiece is less than said Ductile-Brittle Transition Undeformed Chip Thickness, DBhₘ of the material.

2. The method according to claim 1, wherein the Undeformed Chip Thickness, hₘ is in the range of 0.05 to 0.30 μm.

3. The method according to claim 2, wherein the Undeformed Chip Thickness, hₘ, is in the range of 0.20 to 0.25 μm.

4. The method according to claim 1, wherein the workpiece comprises zirconia and the Ductile-Brittle Transition Undeformed Chip Thickness, DBhₘ is between 0.15 and 0.25 μm.

5. The method according to claim 1, wherein the workpiece comprises glass and the Ductile-Brittle Transition Undeformed Chip Thickness, DBhₘ is between 0.10 and 0.30 μm.

6. The method according to claim 1, wherein the workpiece comprises sapphire and the Ductile-Brittle Transition Undeformed Chip Thickness, DBhₘ is between 0.05 and 0.15 μm.

7. The method according to claim 1, wherein operating the milling tool comprises controlling any one or more of the following: the depth of cut, the table feed, spindle speed.

8. The method according to claim 7, wherein the depth of cut is in the range of 5 to 100 μm.

9. The method according to claim 7, wherein the table feed is 200 to 1500 mm/min.

10. The method according to claim 7, wherein the spindle speed is in the range of 1000 to 30000 rpm.

11. The method according to claim 1, wherein the milling tool has an outer diameter in the range of 1 to 15 mm.

12. The method according to claim 11, wherein the milling tool has an outer diameter in the range of 4 to 10 mm.

13. (canceled)

14. The method according to claim 1, wherein the tool head comprises a plurality of flutes arranged in a peripheral surface thereof.

15. The method according to claim 14, wherein the quantity of flutes on the milling tool is in the range of 1 to 200.

16. The method according to claim 1,
wherein the milling tool is an end milling tool.

17. The method according to claim 1, wherein the superhard material comprises any of high pressure high temperature polycrystalline diamond, chemical vapour deposition diamond, and polycrystalline cubic boron nitride.

18. The method of claim 17, wherein the superhard material comprises polycrystalline chemical vapour deposition diamond coated on a cemented carbide substrate.

19. The method of claim 17, wherein the superhard material is monolithic polycrystalline diamond.

20. The method of claim 17, wherein the superhard material is polycrystalline diamond adjoining a carbide backing portion.

21. The method according to claim 1, wherein the tool head comprises at least two tiers, and wherein the tiers are axially displaced from each other and separated by a non-cutting portion of the tool head.
